(19) United States
(12) Patent Application Publication
(10) Pub. No.: US 2009/0050677 A1
(43) Pub. Date: Feb. 26, 2009

(54) METHOD OF WELDING ELECTRONIC COMPONENTS ON PCBS

(75) Inventors: JIAN-YI HAO, Shenzhen City (CN); I-HSIEN CHIANG, Tayuan (TW); CHENG-HSIEN LIN, Tayuan (TW)

Correspondence Address: PCE INDUSTRY, INC.;ATT. CHENG-JU CHIANG, 458 E. LAMBERT ROAD, FULLERTON, CA, 92835, US

(73) Assignees: FUKUI PRECISION COMPONENT (SHENZHEN) CO., LTD., Shenzhen City (CN); FOXCONN ADVANCED TECHNOLOGY INC., Tayuan (TW)

(21) Appl. No.: 12/102,613

(22) Filed: Apr. 14, 2008

(30) Foreign Application Priority Data
Aug. 24, 2007 (CN) 200710076568.1

(51) Int. Cl. B23K 31/02

(52) U.S. Cl. 228/179.1

(57) ABSTRACT

An exemplary method of welding electronic components on PCBs is disclosed. Firstly, a metal tray including a number of supporting areas is provided. At least one through hole is formed in each of the supporting areas. Secondly, solder pastes are applied onto welding pads of PCBs. Thirdly, electronic components are mounted on the welding pads. Fourthly, PCBs are placed on the metal tray in a manner that each printed circuit board is placed in a corresponding supporting area and the welding pads being above the through hole. Finally, the solder pastes are heated to weld the electronic components on the printed circuit board. By doing so, the heat can pass through the through holes in each supporting area directly and fully melt the solder paste. As a result, welding defects can be reduced.

### BACKGROUND

1. Technical Field

The present invention relates to a method of welding electronic components, and especially to a method of welding electronic components onto printed circuit boards (PCBs).

2. Discussion of Related Art

Recently, as the electronic appliances are becoming smaller in size and diversified in function, printed circuit boards (PCBs) widely used in such electronic appliances which are required to have high circuit density and reliability.

Usually, a number of electronic components, such as resistors and capacitors, are mounted on PCBs. Surface mounting technology (SMT) is widely used in packaging such electronic components onto PCBs. Generally, in a packaging process, PCBs are placed on a metal tray, solder pastes are applied on welding pads of the PCBs, electronic components are disposed on the welding pads, and the solder pastes are heated and melted in an oven thereby welding the electronic components on the welding pads of the PCBs. The metal tray is usually made of metal; therefore, the metal tray will absorb heat in the oven and solder pastes may be inefficiently heated, resulting in defective welding joint.

Therefore, there is a desire to develop a method of welding electronic components on PCBs, in which the solder pastes are fully melted; thereby a better welding result is obtained.

### SUMMARY OF THEN INVENTION

An exemplary method of welding electronic components on PCBs is disclosed. Firstly, a metal tray including a number of supporting areas is provided. At least one through hole is formed in each of the supporting areas. Secondly, solder pastes are applied onto welding pads of PCBs. Thirdly, electronic components are mounted on the welding pads. Fourthly, PCBs are placed on the metal tray in a manner that each printed circuit board is placed in a corresponding supporting area and the welding pads being above the through hole. Finally, the solder pastes are heated to weld the electronic components on the printed circuit board.

This and other features and advantages of the present invention as well as the preferred embodiments thereof and a method of welding electronic components on PCBs in accordance with the invention will become apparent from the following detailed description and the descriptions of the drawings.

### BRIEF DESCRIPTION OF THE DRAWINGS

Many aspects of the present invention can be better understood with reference to the following drawings. The components in the drawings are not necessarily drawn to scale, the emphasis instead being placed upon clearly illustrating the principles of the present invention.

FIG. 1 illustrates a method of welding electronic components on printed circuit board (PCB).

FIG. 2 illustrates a metal tray configured for supporting printed circuit board.

FIG. 3 illustrates a PCB.

FIG. 4 illustrates solder pastes are applied on PCB of FIG. 3.

FIG. 5 illustrates the PCB with solder pastes applied thereon is disposed on the metal tray of FIG. 2.

FIG. 6 illustrates a metal tray in accordance with another embodiment. and

FIG. 7 illustrates a metal tray in accordance with still another embodiment.

### DETAILED DESCRIPTION OF THE PREFERRED EMBODIMENTS

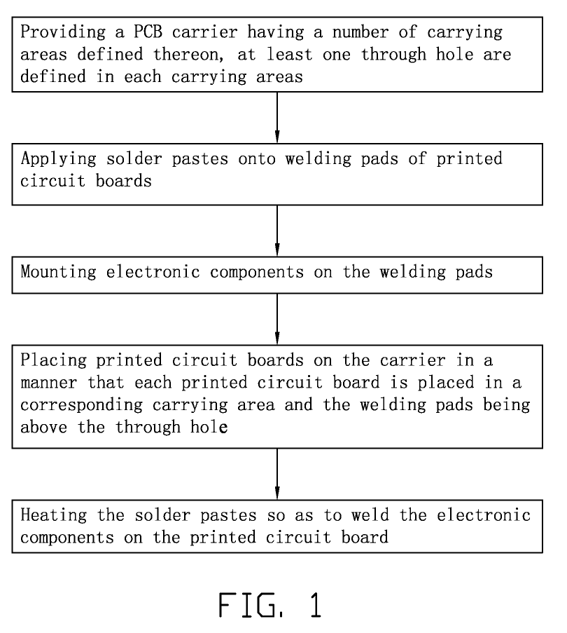

FIG. 1 illustrates a method of welding electronic components on a printed circuit board (PCB) in accordance with an embodiment. The method will be described in detail with the drawings.

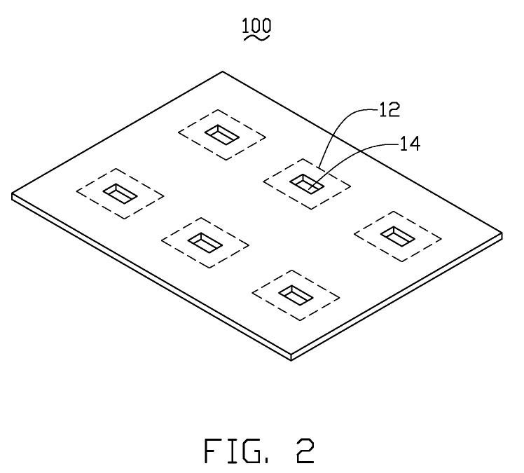

Referring to FIG. 2, a metal tray 100 includes a number of supporting areas 12 defined on a surface of the metal tray 100. A through hole 14 is defined in each of the supporting areas 12. The metal tray 100 can be made of a metal plate or metal alloy plate such as aluminum plate, aluminum alloy plate and magnesium alloy plate. The through hole 14 can be circular or polygonal, for example, rectangular shaped or square shaped. The through hole 14 can be formed using a stamping method or milling method.

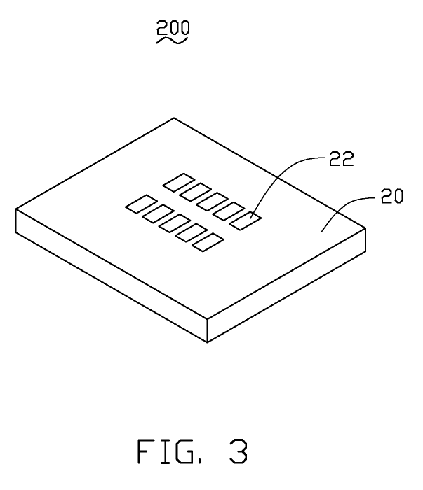

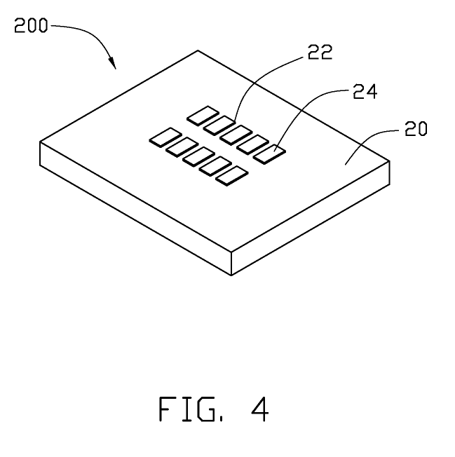

FIG. 3 illustrates a PCB 200 to be packaged with electronic components. The PCB 200 includes a substrate 20 and a number of welding pads 22 formed on a surface of the substrate 20. Referring to FIG. 4, solder paste 24 is applied onto a surface of each welding pad 22. The solder paste 24 can be printed onto each welding pad 22 using a screen printing method. For example, a metal template including a number of through holes corresponding to the welding pads 22 can be disposed above the PCB 200 and then solder paste 24 is placed on the metal template; a scraper is used to apply a pressure onto the solder paste 24 thereby pressing the solder paste 24 to pass through the through hole 14 and remains on the welding pads 22.

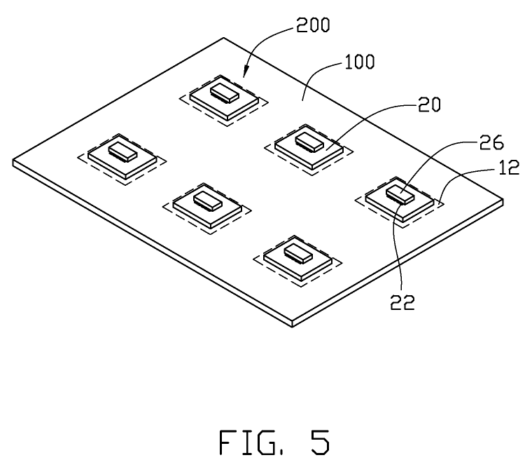

Referring to FIG. 5, a number of PCBs 200 with solder paste 24 applied thereon are placed on the metal tray 100. Each PCB 200 is disposed in a corresponding supporting area 12 and the welding pads 22 are aligned with the through hole 14 in the metal tray 100. In other words, the welding pads 22 are located above the corresponding through hole 14. Electronic components 26 are mounted on the welding pads 22. In the present embodiment, the electronic components 26 are mounted using a surface mounting technology (SMT). The electronic components 26 can be selected from the group consisting of resistor, capacitor, diode, audion, integrated chip (IC) etc.

The metal tray 100 and the PCBs 200 disposed on the metal tray 100 are placed in an oven so as to heat the solder paste 24. The solder paste 24 is then melted and the electronic components 26 are bonded to the welding pads 22 respectively.

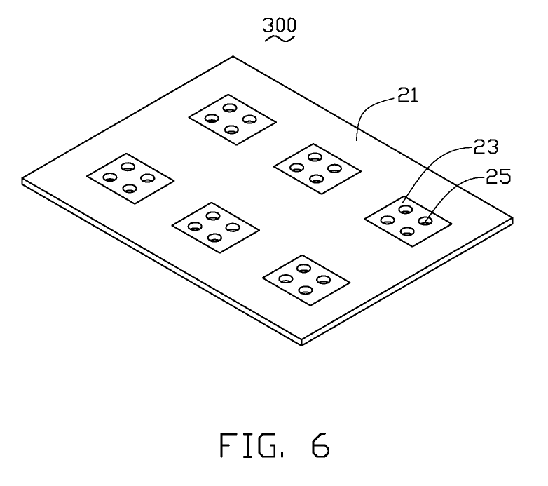

In the metal tray 100, a through hole 14 is defined in each of the supporting area 12, however, it is to be understood that more than one through hole can also be defined in each of the supporting area 12. FIG. 6 illustrates a metal tray 300 configured for supporting PCBs. The metal tray 300 includes a metal plate 21. A number of supporting areas 23 are defined on a surface of the metal plate 21. Four through holes 25 are formed in each of the supporting area 23.

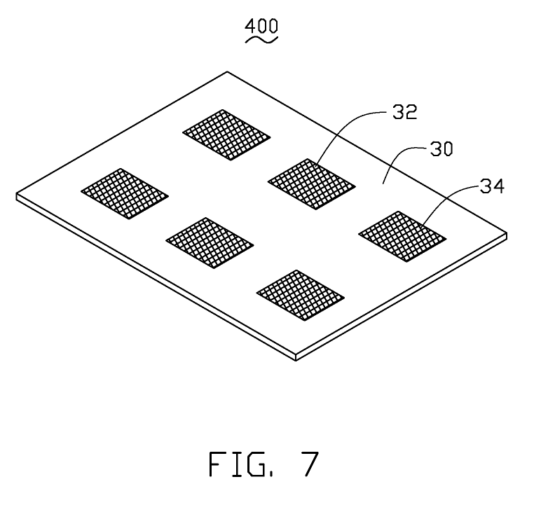

FIG. 7 illustrates a metal tray 400 configured for supporting PCBs. The metal tray 400 includes a metal plate 30. The metal plate 30 defines a number of supporting areas 32 thereon. Each supporting area 32 is formed into a meshwork. A number of meshes/through holes 34 are defined in each of the supporting area 32. In other words, each supporting area 32 defines a meshwork structure therein.

In the metal tray 300 and 400, when a PCB is disposed in a corresponding supporting area 32 thereof, the PCB corresponds to four or more through holes 25. When the metal tray 200 and 300 are disposed in an oven, heat can reach the PCB directly through the through holes 25, thus the solder paste can be sufficiently melted.

Finally, it is to be understood that the above-described embodiments are intended to illustrate rather than limit the invention. Variations may be made to the embodiments without departing from the spirit of the invention as claimed. The above-described embodiments illustrate the scope of the invention but do not restrict the scope of the invention.

What is claimed is:

1. A method of welding electronic components on PCBs, the method comprising:
providing a metal tray, the metal tray comprising a plurality of supporting areas, at least one through hole being defined in each of the supporting areas;
applying solder paste onto welding pads of each of the PCBs;
mounting electronic components on the respective welding pads;
placing the PCBs on the metal tray in a manner that each PCB is placed in the corresponding supporting area, the welding pads being disposed above the at least one through hole; and
heating the solder pastes to weld the electronic components on the respective printed circuit boards.

2. The method of welding electronic components on PCBs as claimed in claim 1, wherein the metal tray is made of a material selected from the group consisting of aluminum, aluminum alloy and magnesium alloy.

3. The method of welding electronic components on PCBs as claimed in claim 1, wherein the at least one through hole is circular or polygon in shape.

4. The method of welding electronic components on PCBs as claimed in claim 1, wherein the solder paste is applied on the PCBs using a screen printing method.

5. The method of welding electronic components on PCBs as claimed in claim 1, wherein the metal tray has a meshwork structure in each of the supporting areas.
